(19) United States
(12) Patent Application Publication
(10) Pub. No.: US 2011/0173052 A1
(43) Pub. Date: Jul. 14, 2011

(54) Enhanced Knowledge Management

(75) Inventor: Madhuri Deshpande, Mumbai (IN)

(73) Assignee: Bank of America Corporation, Charlotte, NC (US)

(21) Appl. No.: 12/685,810

(22) Filed: Jan. 12, 2010

(51) Int. Cl. G06Q 10/00; G06N 5/02

(52) U.S. Cl. 705/7.39; 706/54; 705/7.42

(57) ABSTRACT

A knowledge management module associated with an organization hierarchically arranges knowledge relevant to the organization. The knowledge management module may communicate with databases internal and external to the organization to connect individuals to information regarding elements within the map. In certain embodiments, the management server also includes, for each element in the knowledge management map, information related to the levels of expertise of personnel associated with the organization. In another embodiment, the knowledge management module may include processing capabilities that allow it to recompute the links between each element of the map when errors have been found or when new elements need to be added.

### TECHNICAL FIELD

Aspects of the invention generally relate to enhanced knowledge management capabilities. In particular, various aspects of the invention include a framework for associating knowledge about products, services, and applications supported at an organization with the levels of expertise possessed by personnel in the organization for that knowledge.

### BACKGROUND

Currently, entities such as companies, departments within companies, and/or universities struggle with the fact that there are disparate areas of expertise present through the documents, personnel, and applications that may exist there. For example, documentation may not be consistent across the entire organization. Oftentimes, few people, if any, at the organization know whether the documentation that is available is complete, current, or even accurate.

The problem becomes even more acute at organizations where the attrition or turnover rate is high. When personnel leave the organization, they may take specific knowledge with them, leaving the applications supported by that knowledge and the documentation describing it in a state of disrepair. For instance, when a key member of a team involved in a process leaves the organization for some reason, there is often little guidance on how the knowledge represented by the team member may be replaced by existing personnel.

While methodologies and standards such as the International Organization for Standardization (ISO) 9001 standard and the capability maturity model integration (CMMI) methodology aim to produce robust processes/applications, these methodologies cannot always ensure that processes/applications supported by an organization are updated, accurate, and complete.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, computer readable media, and apparatuses for structuring knowledge available at an organization. This management tool may be used to arrange the knowledge available at an organization in a hierarchical fashion so that broad concepts are eventually linked to specific technical and functional knowledge.

With another aspect of the disclosure, personnel may be graded on their level of expertise with regard to technical and functional knowledge within a knowledge management module.

Aspects of the disclosure may be provided in a computer-readable medium having computer-executable instructions to perform one or more of the process steps described herein.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and is not limited in the accompanying figures in which like reference numerals indicate similar elements and in which:

FIG. 1 shows an illustrative operating environment in which various aspects of the disclosure may be implemented.

FIG. 2 is an illustrative block diagram of workstations and servers that may be used to implement the processes and functions of certain aspects of the present disclosure.

FIG. 3 shows a system for enhanced knowledge management within an organization in accordance with an aspect of the disclosure.

FIG. 4 shows a hierarchical framework for managing knowledge within an organization in accordance with an aspect of the disclosure.

FIG. 5 shows a process for enhanced knowledge management at an organization in accordance with an aspect of the disclosure.

### DETAILED DESCRIPTION

As discussed above, there are problems associated with the way knowledge is currently managed within an organization. For instance, documents may be arranged haphazardly and may thus not be updated properly when needed.

In accordance with various aspects of the disclosure, methods, computer-readable media, and apparatuses are disclosed in which an organization may access, update, and correct relevant documents related to applications/products/services that the organization may support and/or sell. An organization, e.g., a company, may use aspects of the disclosure to train personnel in acquiring knowledge that they currently lack. To provide this service, an organization may use a computing device to create a knowledge map that hierarchically associates knowledge available through services, products, and personnel at the organization. Within this structure, generalized knowledge in a particular domain is subcategorized and eventually linked to knowledge about specific products, applications, and services that are supported by the organization. These can be classified into categories such as “functional knowledge”, “technical knowledge” or any other similar category suitable to the application. In addition, knowledge maps may be created for specialized knowledge. Thus, knowledge maps may be created and associated with different levels of understanding of an application or service provided by the organization.

Once all of the products, services, and applications have been mapped in a data processing tool (e.g., a computer), links may be provided to data related to a particular element in the mapping. These links (e.g., shortcuts, HTML tags, etc.) may reference information related to the element located on internal databases, external databases, and the interne, among other places.

Next, the map that is generated may be used as an aid in categorizing different levels of knowledge associated with a particular application, product, and/or service offered/supported by the organization. For instance, a person with no knowledge, or one who does not possess knowledge associated with the items categorized in the knowledge map for the generalist level in a particular area may be a beginner. A generalist may know only a few things about a particular application whereas a specialist or a subject matter expert may know much more. The specific benchmarks used to attain each of these levels of knowledge may be developed by senior management, application experts, and/or consulting firms. The knowledge map may aid in developing these benchmarks by identifying the extent of knowledge available at the organization, or which an organization desires to have. These benchmarks may be used in classifying personnel with a particular knowledge level for each product, application, and/or service. These classifications may in turn be used to create structured development plans for personnel that wish to “graduate” to higher classifications.

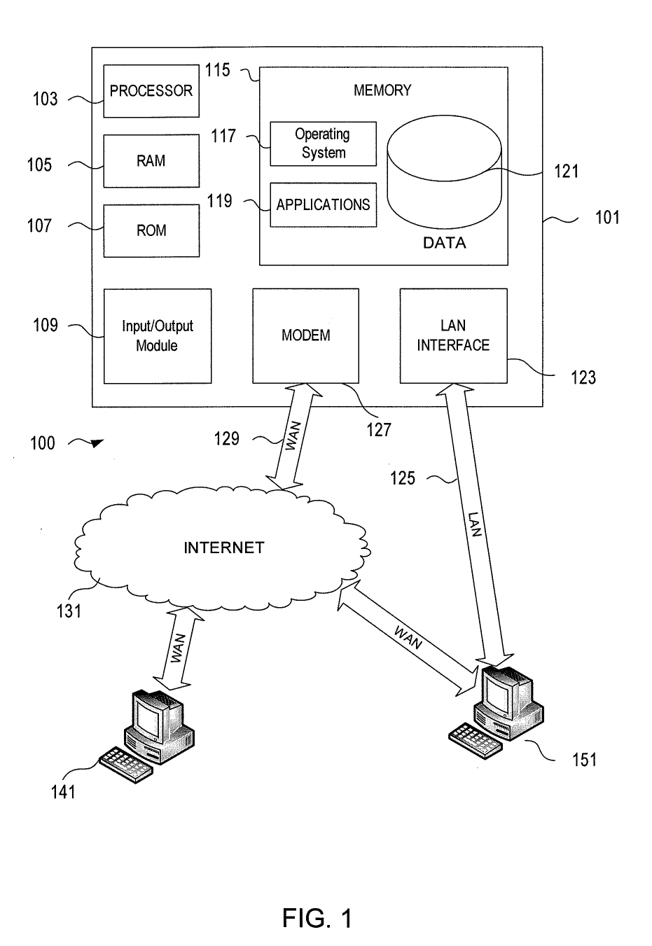

FIG. 1 illustrates a block diagram of knowledge management module/device 101 (e.g., a computer server) in communication system 100 that may be used according to an illustrative embodiment of the disclosure. The device 101 may have a processor 103 for controlling overall operation of the knowledge management module 101 and its associated components, including RAM 105, ROM 107, input/output module 109, and memory 115.

I/O 109 may include a microphone, keypad, touch screen, and/or stylus through which a user of knowledge management module 101 may provide input, and may also include one or more of a speaker for providing audio output and a video display device for providing textual, audiovisual and/or graphical output. Software may be stored within memory 115 and/or storage to provide instructions to processor 103 for enabling device 101 to perform various functions. For example, memory 115 may store software used by the device 101, such as an operating system 117, application programs 119, and an associated database 121. Processor 103 and its associated components may allow the device 101 to run a series of computer-readable instructions to store and compute the relationships between various knowledge domains present within an organization such as a company or a university in a hierarchical fashion. For instance, if a manager at a software company wishes to determine who at his company knows about advanced coding schemes in JAVASCRIPT™, the manager may access device 101 to find that only one of his senior design engineers possesses the knowledge that he seeks. Alternatively, he may not find anyone at his company with the knowledge he seeks. Therefore, he may then ask one of his software programmers to acquire the knowledge through a personalized training or development plan structured around benchmarks that may be extracted from/added to the knowledge map in database 121.

The server 101 may operate in a networked environment supporting connections to one or more remote computers, such as terminals 141 and 151. The terminals 141 and 151 may be personal computers or servers that include many or all of the elements described above relative to the computing device 101. Alternatively, terminal 141 and/or 151 may be a knowledge data store associated with an organization and accessed by server 101. The network connections depicted in FIG. 1 include a local area network (LAN) 125 and a wide area network (WAN) 129, but may also include other networks. When used in a LAN networking environment, the server 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the knowledge management module 101 according to an illustrative embodiment of the disclosure may include computer executable instructions for invoking functionality related to associating different knowledge domains and personnel who possess expertise in those knowledge domains in a hierarchical fashion.

Knowledge management module 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

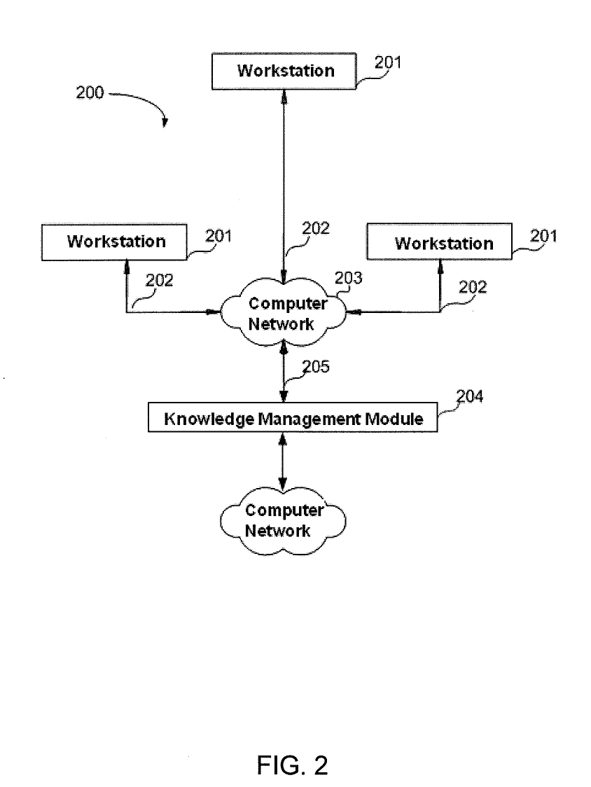

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to knowledge management module 204. In certain embodiments, workstations 201 may be different data stores for storing and/or indexing knowledge referenced in the knowledge map of server 204 or in other embodiments workstations 201 may be different points at which the computing device may be accessed. In system 200, knowledge management module 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

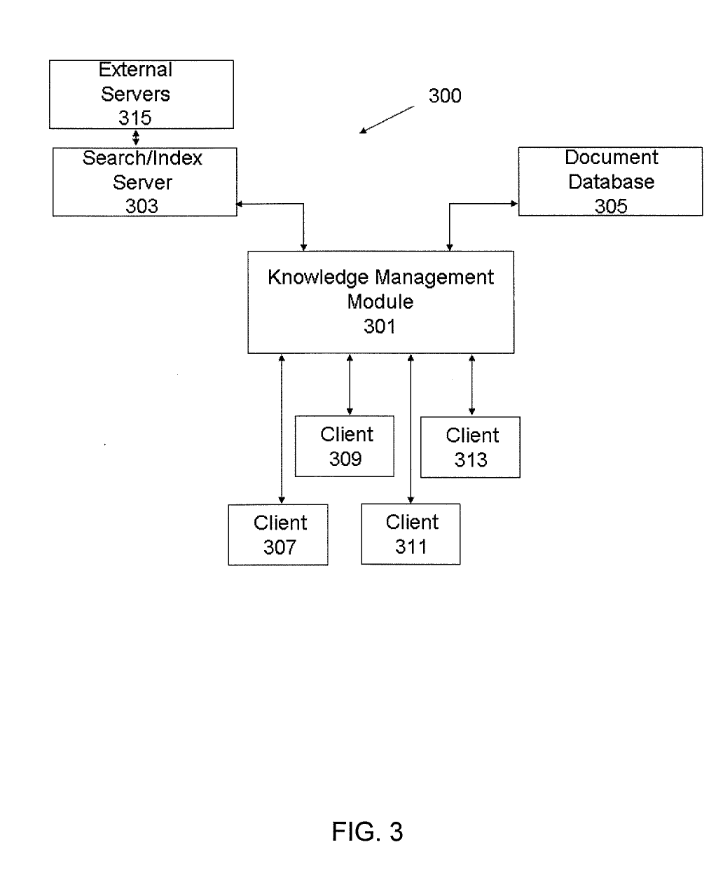

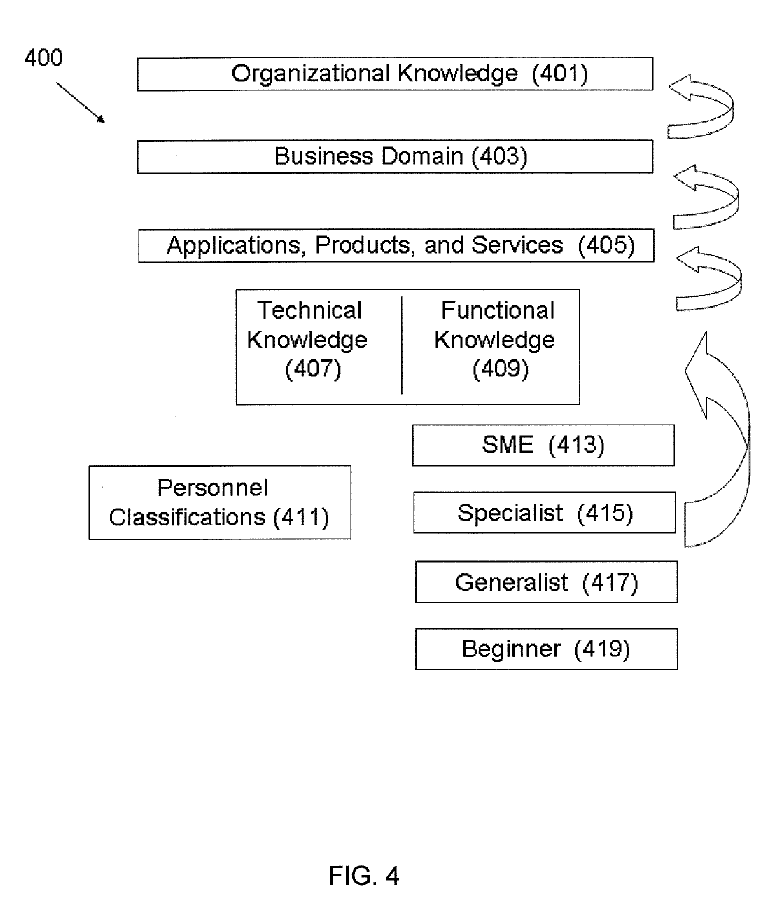

FIG. 3 shows a system 300 for storing and indexing knowledge in accordance with an aspect of the invention. System 300 includes a knowledge management module 301 that may manage the knowledge present in an organization. Knowledge management module 301 may arrange the knowledge present within an organization in a hierarchical fashion, such as that shown in the example hierarchy 400 of FIG. 4.

For instance, in FIG. 4, organizational knowledge 401 may be divided into business domain knowledge 403. For instance, a financial entity (e.g., a bank) may divide knowledge about the financial industry into various business domains, including home loans, corporate accounts, credit card transactions, and investment banking, among other areas. At the next level in the hierarchy, each business domain may support various applications, products, and services 405. For instance, in the example of a bank, each of the business domains 403 mentioned above may support specialized software tools and products. As an example, the credit card transactions department of a bank may support applications related to internet billing, transaction history analysis, and/or rewards programs, among other things. Other organizations such as department stores, car dealers, hospitals, and law firms may divide business domain knowledge into other areas; for instance, a car dealer may divide organizational knowledge into such business domains as new car sales, used car sales, leasing, and trade-ins. Applications that support each of these domains may include software products that track inventories, transactions, and customer information for each of these domains. Alternatively, products may also represent different models of cars, electromechanical car parts, and different types of repairs, among other things.

Application level knowledge 405 may further be divided into areas such as technical knowledge 407 and/or functional knowledge 409. For instance, technical knowledge about car repair services may include the specifications of how different car engines are put together and functional knowledge may include directions on how to fix a particular problem and/or replace a used part for a particular car model and make. It should be noted that alternative schemes/methodologies may be used to represent organizational knowledge 401 within organizations such as companies, schools, and universities, among other places.

The hierarchy 400 may also include personnel classifications 411 that represent the expertise levels of personnel that work at an organization. Many different schemes for classifying expertise levels may be used. In the example shown in FIG. 4, personnel may be classified as a subject matter expert (SME) 413, specialist 415, a generalist 417, or a beginner 419. A subject matter expert, as the name implies, may possess a great deal of knowledge (functional and/or technical) related to particular applications, products, or services 405. A specialist 415 may possess somewhat less knowledge than a subject matter expert 413 but enough to tackle difficult problems with a particular field. A generalist may have basic knowledge of the particular application, product or service. Finally, a beginner 419 may be quite new to a particular field and may show mastery of few, if any, concepts regarding a particular application, product, and/or service 405.

In other classification schemes, many more levels of expertise 411 may be present. Alternatively, the classifications 411 may be directly based on job titles, such as software programmer, software engineer, senior software engineer, and manager, among other things.

Going back to FIG. 3, knowledge management module 301 in system 300 may be in communication with a search/index server 303 and a document database server 305. Search/index server 303 may include a processor 103 to index and search for knowledge elements that are a part of the hierarchical mapping in knowledge management module 301. For instance, if a user at a financial entity wishes to learn more about knowledge related to credit card transactions, the user may click on a link entitled “credit card transactions” within the mapping provided in server 301. By clicking on this link, management server 301 may communicate with search/index server 303 to connect the user with a proper external database 315 with documents related to credit card transactions. External servers 315 may represent computing resources at libraries, web servers at companies, and/or off site remote servers that are still a part of an organization. In other embodiments, search/index server 303 may house all the information necessary for a user.

Knowledge management module 301 may also be in communication with a document database server 305. Document database server 305 may serve as a repository for documents that are created/housed internal to the organization. When a user requests information about a particular topic from the knowledge management module 301, system 300 may have in place a protocol for determining whether to access search/index server 303 and/or document database server 305. For instance, system 300 may first access document database server 305, and if no documents related to the request are found there, system 300 may then access search/index server 303. Alternatively, the functionality provided in document database server 305 and search/index server 303 may be combined into one server.

System 300 also may include thin clients 307-313 for accessing knowledge management module 301. For instance, personnel at an organization may use thin clients 307-313, one of which may be placed in their office for easy access to and use of knowledge management module 301. In general, thin clients 307-313 may include any general purpose computing device, such as device 101.

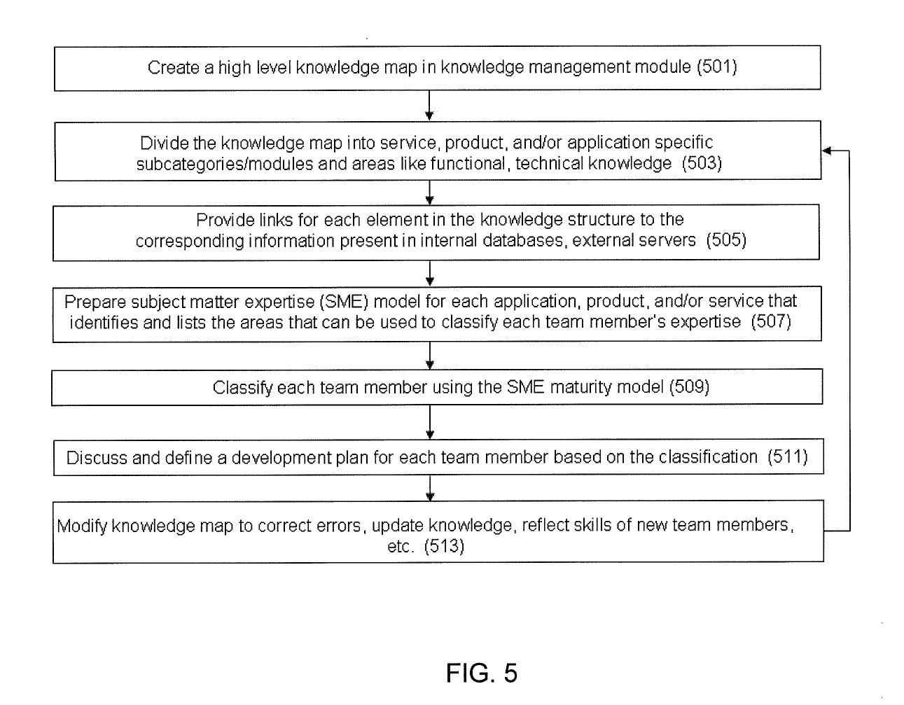

FIG. 5 illustrates a method for enhanced knowledge management within, an organization in accordance with certain aspects of the disclosure. The method starts out at step 501 where a high level knowledge map may be created within the knowledge management module 301. The high level knowledge map may include general organization categories 401 or business domains 403 that are of interest to an organization. Then the process may move to step 503 where the elements within the knowledge map may be divided into service, product, and/or application-specific subcategories/modules 405 and areas like functional 409 and/or technical 407 knowledge. As discussed above, this knowledge may represent more specialized expertise at an organization. Functional knowledge 409 may refer to practical knowledge useful for everyday needs whereas technical knowledge 407 may refer to basic concepts or theories underlying the practical implementation.

Once a complete knowledge tree has been mapped within knowledge management module 301, each element of the tree may be linked to information regarding that element located in internal databases 305 and/or external servers 315 in step 505. As discussed above, external servers may be accessed through a search/index server 303. In alternative embodiments, information regarding each of the elements that are a part of the knowledge structure may be found internal to the knowledge management module 301. Where precise information does not exist, or is not available to the organization, a link to an empty document in the document database server 305 may be created. This will help the organization determine the gaps in existing knowledge within the organization, and it can then enlist the subject matter experts to create appropriate information within the document database 305.

Once all the knowledge has been mapped and the documents/information underlying each knowledge element has been linked to the mapping at the generalist level, the process may then move to step 507 where a subject matter expertise (SME) model may be prepared for each application, product, and/or service 405. The SME model may identify and list the areas that may be used to classify the expertise of each person that may be a part of the organization. This model may set benchmarks/rubrics for moving to higher levels of expertise 411. For instance, in deciding which level of expertise to classify a software programmer, an organization may decide to use the following classifications 411. A beginner may be an individual with little to no knowledge about a particular software application. Meanwhile, a generalist 417 may have been introduced to the application several months ago and attained a rudimentary understanding of certain programming features. Further still, a specialist 415 may have mastered the basics of the software application and spent considerable time in mastering a particular aspect of the software application, such as in using the application to solve complex problems, fixing bugs within the application for specific cases, and/or recoding the application for new problems. Finally, a subject matter expert (SME) 413 may be one that not only has a deep understanding of the software application but also of similar applications within the business domain 403. In certain embodiments, the classifications 411 may be quantified such that a particular level of expertise may be associated with a number. Additionally, sublevels within each level of expertise may indicate a more detailed level of expertise within each classification. It should be noted that these classifications 411 have been arbitrarily chosen and other classification/benchmark methodologies are within the scope of the disclosure. Weights may be assigned for each item, or each item may have equal weights.

The process may then move to step 509 where each person within an organization may be classified using the SME maturity model developed in step 507. The classification may be used to discuss and define a development/learning plan for each person in step 511. For instance, using the example of a software programmer discussed above, the specific benchmarks for moving from a generalist to a specialist may be in learning how certain subroutines within an application are coded, how a particular application fails under complex scenarios, and/or how to train others in learning an application. Each of these benchmarks may be weighted differently in allowing the individual to move from one expertise sublevel to another. In other embodiments, all of the benchmarks may be equally-weighted in determining the progression of an individual from one expertise sublevel to another.

A manager, for instance, may use this framework to promote an individual in his business department from one classification to another. For instance, the framework may be used to define specific knowledge that an individual may need to acquire to move from a generalist category to a specialist. The individual seeking to gain new knowledge may access the knowledge management module 301 to learn this new knowledge. In some cases, the knowledge management module 301 may not include a mapping and/or may include an incorrect mapping for the specific knowledge that an individual seeks. In this case, the individual may add the knowledge to/change the mapping in the server 301 as she gains familiarity with the knowledge, as shown in step 513. In this way, the knowledge mapping in the knowledge management module 301 may represent a constantly evolving structure that is updated, corrected, and accessed. Once the individual seeking new knowledge has mastered the information set out in her development plan, she may be required to give a presentation, pass an exam, and/or solve a practical problem to officially move to a higher expertise classification. In other embodiments, she may automatically move to a higher classification upon reading/understanding all of the information related to a topic accessible through the knowledge management module 301.

In other embodiments, the knowledge management module 301 may have enhanced processing capabilities that allow the server 301 to recompute the knowledge map (i.e., reconnect the links between knowledge elements within the map) when new knowledge elements are added. In this scenario, a user may input a new element into server 301 and a processor within server 301 may analyze the keywords of the new element to determine where in the existing knowledge map to place the new element. In other embodiments, the links linking the elements of the map may be weighted to distinguish more important knowledge about applications, products, and services from outdated or less important knowledge. In this scenario, the processor of the server 301 may also recompute the weights associated with the links when updates to the map need to be made.

In some examples, access to sensitive organizational information such as the expertise classifications 411 of personnel may be restricted to only those that have the proper authorization. For instance, a manager at a company may need to know this information to properly develop training plans for his staff and gauge their progress for performance reviews, promotions, and/or rewards/disciplinary actions. However, others at the company may not be allowed access to this individual's level of expertise classification 411 within the server 301.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. A computer-assisted method comprising:
(i) creating, on a memory, a map of knowledge elements of an organization;
(ii) using a processor, linking through a plurality of links the knowledge elements to corresponding information located in a plurality of computing devices, wherein information in each link is related to its corresponding knowledge element;
(iii) preparing, using a processor, a model in the memory detailing a plurality of benchmarks for attaining a plurality of expertise levels for knowledge elements in the map;
(iv) recording, on the memory, a classification of an individual associated with the organization with a first expertise level of the plurality of expertise levels for a knowledge element in the map; and
(v) using the classification of the individual and the plurality of benchmarks, customizing a development plan for attaining a second expertise level of the plurality of expertise levels by the individual.

2. The method of claim 1 further comprising repeating steps (iv) and (v) for each individual associated with the organization.

3. The method of claim 1 further comprising repeating steps (iv) and (v) for each knowledge element in the map.

4. The method of claim 1, wherein the map is arranged in a hierarchical order such that broad knowledge elements are listed on top of the map and more specific knowledge elements are listed at the bottom of the map.

5. The method of claim 4, wherein the hierarchical order, arranged from most general knowledge to most specific knowledge, comprises organizational knowledge, business domain knowledge, and application-specific knowledge.

6. The method of claim 5, wherein the application-specific knowledge is further divided into technical knowledge and functional knowledge.

7. The method of claim 1, wherein the plurality of computing devices comprise databases located both internal and external to the organization.

8. The method of claim 1, wherein the plurality of expertise levels is chosen from the group consisting of: beginner, generalist, specialist, and subject matter expert.

9. The method of claim 1, further comprising: modifying the map to correct errors in the map.

10. The method of claim 1, further comprising modifying the map to add knowledge elements to the map.

11. The method of claim 1, wherein the plurality of expertise levels are quantified.

12. The method of claim 1, further comprising: restricting access to a portion of the memory device such that only authorized personnel are allowed to view the individual's classification.

13. The method of claim 1, wherein the model is configured to allow the individual to advance from beginner to subject matter expert based on the number of knowledge elements that the individual knows for a particular topic.

14. A computer-readable storage medium having computer-executable program instructions stored thereon that when executed by a processor, cause the processor to perform steps comprising:
(i) displaying a hierarchical knowledge map comprising a plurality of knowledge elements relevant to an organization on a display wherein the knowledge map further comprises benchmarks for attaining a plurality of expertise levels for each knowledge element in the knowledge map;
(ii) receiving an identification of a first knowledge element of the plurality of knowledge elements;
(iii) transmitting a request to a storage device for information regarding the first knowledge element;
(iv) receiving the information from the storage device; and
(v) for the first knowledge element, updating an expertise level of an individual associated with the organization.

15. The computer-readable storage medium of claim 14, wherein the computer-executable instructions further perform: updating the knowledge map with new knowledge elements.

16. The computer-readable storage medium of claim 14, wherein the computer-executable instructions further perform: assigning weights to links linking the knowledge elements in the knowledge map, wherein each weight defines a degree to which a knowledge element in the map is important to the organization.

17. The computer-readable storage medium of claim 16, wherein the computer-executable instructions further perform: recomputing the weights upon entry of new knowledge elements.

18. An apparatus comprising:
(i) a knowledge management module configured to generate and store a knowledge management map, wherein the knowledge management map comprises a plurality of knowledge elements that represent knowledge relevant to a particular organization;
(ii) a communication module configured to communicate with a plurality of computing devices to retrieve and display information related to each of the plurality of knowledge elements within the knowledge management map;
(iii) a processor configured to prepare a model detailing a plurality of benchmarks for attaining a plurality of expertise levels for the plurality of knowledge elements in the knowledge management map; and
(iv) a memory configured to store the knowledge management map and a classification of individuals associated with the organization.

19. The apparatus of claim 18, wherein the knowledge management module is configured for access by thin clients located remotely from the knowledge management module.

20. The apparatus of claim 18, wherein the processor further recomputes the knowledge management map upon entry of new knowledge elements to the knowledge management map.
